(19) United States
(12) Patent Application Publication
(10) Pub. No.: US 2021/0220869 A1
(43) Pub. Date: Jul. 22, 2021

(54) ALIGNMENT FILM COATING METHOD AND COATER

(71) Applicant: WUHAN CHINA STAR OPTOELECTRONICS TECHNOLOGY CO., LTD., Wuhan (CN)

(72) Inventor: Junfeng Zheng, Wuhan (CN)

(21) Appl. No.: 16/309,053

(22) PCT Filed: Sep. 4, 2018
(86) PCT No.: PCT/CN2018/103914

§ 371 Date: Dec. 11, 2018

(30) Foreign Application Priority Data
Aug. 17, 2018 (CN) 201810937976.X

(51) Int. Cl. B05D 1/28; G02F 1/1337; B05C 1/08; B05C 11/10; B05C 13/02

(52) U.S. Cl. CPC B05D 1/28; G02F 1/1337; G02F 1/1303; B05C 11/10; B05C 13/02; B05C 1/0813

(57) ABSTRACT

An alignment film coating method is provided, and includes steps of: supplying alignment film solution to a coating roller at a first end of a machine table; placing a first substrate on the machine table; moving the coating roller from the first end to a second end of the machine table; supplying alignment film solution to the coating roller at the second end of the machine table; taking the first substrate down from the machine table, and placing a second substrate on the machine table; and, linearly moving the coating roller from the second end to the first end of the machine table.

### FIELD OF THE INVENTION

The present disclosure relates to the technical field of coating of an alignment film onto a substrate, and in particular to an alignment film coater and a coating method.

### DESCRIPTION OF THE RELATED ART

At present, during the manufacturing of a liquid crystal display panel, generally, a layer of alignment film is first fabricated on a Thin Film Transistor (TFT) substrate and a Color Filter (CF) substrate; then, a sealant is dispensed on the TFT substrate, liquid crystal drops are filled in the TFT substrate, and the TFT substrate is fitted to the CF substrate in vacuum; and finally, the sealant is solidified by ultraviolet irradiation, so that the TFT substrate and the CF substrate are packaged.

Existing methods for coating of an alignment film onto a substrate are generally implemented by an alignment film coater. In the conventional coating industry, coating substrates of different types in batches is generally implemented as follows: delivering sample sheets after the machine table is powered on, coating alignment films onto TFT substrates (in a whole batch), and coating alignment films onto CF substrates (in a whole batch).

Only after substrates of a certain type in a batch have been coated, substrates of another type can then be coated. As a result, the TFT substrates and the CF substrates cannot be assembled timely. Consequently, the production efficiency is reduced.

### SUMMARY OF THE INVENTION

The present invention provides an alignment film coating method, in order to solve the technical problem in the existing alignment film coating methods that the TFT substrates and the CF substrates cannot be assembled timely and the production efficiency is thus reduced since substrates of another type can be coated only after substrates of a certain type in a batch have been coated.

In order to solve the above problem, the present invention employs the following technical solutions.

An alignment film coating method, including steps of:
S10: supplying alignment film solution to a coating roller at a first end of a machine table;
S20: placing a first substrate on the machine table;
S30: linearly moving the coating roller from the first end to a second end of the machine table to coat an alignment film onto the first substrate;
S40: supplying alignment film solution to the coating roller at the second end of the machine table;
S50: taking the first substrate down from the machine table, and placing a second substrate on the machine table; and
S60: linearly moving the coating roller from the second end to the first end of the machine table to coat an alignment film onto the second substrate.

Preferably, the step S30 includes:
S31: selecting, a position of the coating roller relative to the machine table, the type of a substrate to be placed on the machine table.

Preferably, in the step S31, when the coating roller is located at the first end of the machine table, a CF substrate is placed on the machine table; and, when the coating roller is located at the second end of the machine table, a TFT substrate is placed on the machine table.

Preferably, in the step S31, when the coating roller is located at the first end of the machine table, a TFT substrate is placed on the machine table; and, when the coating roller is located at the second end of the machine table, a CF substrate is placed on the machine table.

The present disclosure further provides an alignment film coater, including:
a machine table;
a coating roller for coating an alignment film;
solution supply mechanisms for supplying alignment film solution to the coating roller; and
a driving member for driving the coating roller to linearly move from one end to the other end of the machine table;
wherein the solution supply mechanisms are arranged at two ends of the machine table.

Preferably, the alignment film coater further comprises a shaping mechanism for transferring the alignment film solution to the coating roller, wherein the shaping mechanism comprises a shaping roller and a mount; and, the shaping roller is connected to the mount in such a way that the shaping roller rotates about its axis, and the shaping roller is parallel to the coating roller.

Preferably, each of the solution supply mechanisms comprises a reservoir, and a nozzle which is communicated with the reservoir and used for spraying the alignment film solution onto the shaping roller.

Preferably, the coating roller is connected to the mount in such a way that the coating roller rotates about its axis, and the shaping roller is located above the coating roller and comes into contact with the coating roller.

Preferably, the alignment film coater further comprises a robot arm for placing a substrate on or taking a substrate down from the machine table.

Preferably, the alignment film coater further comprises a control system for controlling the robot arm, the control system comprising:
a sensing module configured to sense the position of the coating roller and transmit a sensing signal;
a determination module configured to receive the sensing signal, then determine, according to the sensing signal, a position of the coating roller relative to the machine table and generate a result of determination; and
a driving module configured to receive the result of determination and then drive, according to the result of determination, the robot arm to place a substrate of a corresponding type on the machine table.

Advantages of the present disclosure are: by alternately coating the TFT substrate and the CF substrate, the coated CF substrate and the corresponding TFT substrate can be assembled timely, and the production efficiency and the productivity are thus improved. Meanwhile, by separately controlling the coating of alignment film onto the TFT substrate and the CF substrate, this prevents the disorder of the TFT substrate and the CF substrate during the alternate coating process. Since the alignment film solution can be supplied to the coating roller at both ends of the machine table and the alignment film coating can be implemented in left and right directions. In this way, the time for supplying alignment film solution to the coating roller is saved since the coating roller does not need to return to the original position to be supplied with alignment film solution. Meanwhile, this avoids defective products resulted from the drops of the residual alignment film solution on the substrate during the return of the coating roller to its original position.

### BRIEF DESCRIPTION OF THE DRAWINGS

In order to explain the technical solutions in the present embodiments or in the prior art more clearly, accompanying drawings required in the description of the present embodiments or prior art will be briefly described. Obviously, accompanying drawings are just some embodiments of the present disclosure, while other drawings may be obtained by those skilled in the art according to these drawings, without paying out any creative work.

FIG. 1 is a schematic flowchart of coating alignment films according to a specific implementation of the present invention.

FIG. 2 is a schematic structure diagram of an alignment film coater according to a specific implementation of the present invention.

FIG. 3 is a schematic diagram of a robot arm according to a specific implementation of the present invention.

### DETAILED DESCRIPTION OF THE PREFERRED EMBODIMENTS

The following description of the embodiments is used for illustrating, with reference to the accompanying drawings, particular embodiments in which the present invention can be implemented. The directional terms, as used here, such as “upper”, “lower”, “front”, “rear”, “left”, “right”, “inner”, “outer” or “side”, merely refer to the directions shown with reference to the accompanying drawings. Therefore, the directional terms, as used here, are merely for describing and understanding the present invention, rather than limiting the present invention. In the drawings, units of similar structures are denoted by similar reference numerals.

The present disclosure is provided in order to solve the technical problem in the existing alignment film coating methods that the TFT substrates and the CF substrates cannot be assembled timely and the production efficiency is thus reduced since substrates of another type can be coated only after substrates of a certain type in a batch have been coated. The embodiments of the present disclosure are capable of solving the technical problem.

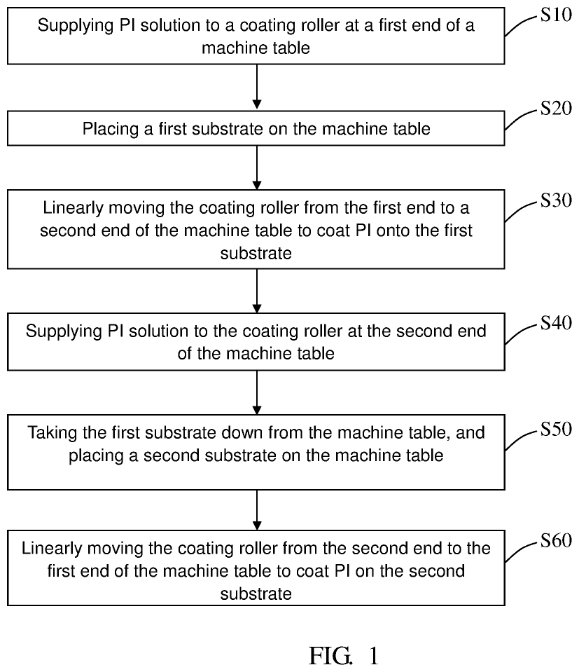

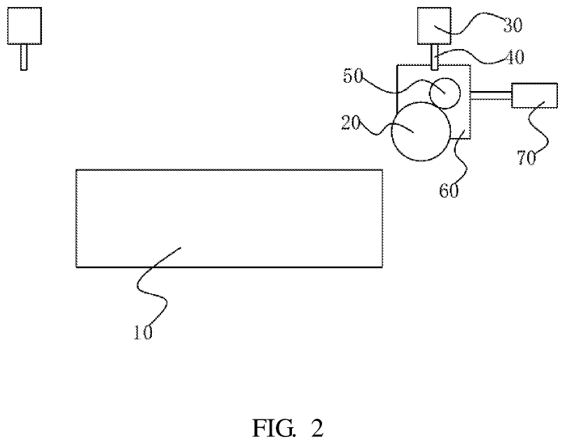

An alignment film coating method is provided, as shown in FIGS. 1 and 2, including steps of:
S10: supplying alignment film solution to a coating roller 20 at a first end of a machine table 10;
S20: placing a first substrate on the machine table 10;
S30: linearly moving the coating roller 20 from the first end to a second end of the machine table 10 to coat an alignment film onto the first substrate;
S40: supplying alignment film solution to the coating roller 20 at the second end of the machine table 10;
S50: taking the first substrate down from the machine table 10, and placing a second substrate on the machine table 10; and
S60: linearly moving the coating roller 20 from the second end to the first end of the machine table 10 to coat an alignment film onto the second substrate.

The machine table 10 is kept still, and the coating roller 20 does periodic reciprocating motion between two ends of the machine table 10 to coat an alignment film onto a substrate on the machine table 10, so that substrates of different types can be coated alternately. After a CF substrate is coated, a TFT substrate can be coated, so that the coated CF substrate and the corresponding TFT substrate can be assembled timely and the production efficiency is thus improved. The alignment film solution can be supplied to the coating roller 20 at both ends of the machine table 10, and the alignment film coating can be implemented in left and right directions. In this way, the time for supplying alignment film solution to the coating roller 20 is saved since the coating roller 20 does not need to return to the original position to be supplied with alignment film solution, and the productivity is thus improved. Meanwhile, this avoids defective products resulted from the drops of the residual alignment film solution on the substrate during the return of the coating roller 20 to its original position.

It is to be noted that, in practical implementations, it is possible to alternately coat the TFT substrates and the CF substrates, or it is also possible to continuously coat multiple substrates of a same type and then substrates of another type, depending upon actual requirements.

Before the step S10, the alignment film coating method further includes a step of:
S70: adjusting the position of the coating roller 20 so that the coating roller 20 is located at the first end of the machine table 10.

It is to be noted that, if the initial position of the coating roller 20 is at the first end of the machine table 10, the step S70 is omitted.

Specifically, the step S30 includes:
S31: selecting, according to a position of the coating roller 20 relative to the machine table 10, the type of a substrate to be placed on the machine table 10.

In an implementation, in the step S31, when the coating roller 20 is located at the first end of the machine table 10, a CF substrate is placed on the machine table 10; and, when the coating roller 20 is located at the second end of the machine table 10, a TFT substrate is placed on the machine table 10.

In another implementation, in the step S31, when the coating roller 20 is located at the first end of the machine table 10, a TFT substrate is placed on the machine table 10; and, when the coating roller 20 is located at the second end of the machine table 10, a CF substrate is placed on the machine table 10.

A substrate of a type is correspondingly placed on the machine table 10 when the coating roller 20 is located at the first end of the machine table 10, while a substrate of another type is correspondingly placed on the machine table 10 when the coating roller 20 is located at the second end of the machine table 10, so the TFT substrate and the CF substrate are alternately coated. This prevents the disorder of the TFT substrate and the CF substrate during the alternate coating process.

An alignment film coater is provided, as shown in FIG. 2, including: a machine table 10, a coating roller 20 for coating alignment film, solution supply mechanisms for supplying alignment film solution to the coating roller 20, and a driving member 70 for driving the coating roller 20 to linearly move from one end to the other end of the machine table 10, wherein the solution supply mechanisms are arranged at two ends of the machine table 10.

The coating roller 20 is driven by the driving member 70 to do linear reciprocating motion so as to coat alignment film onto a substrate on the machine table 10. Meanwhile, by the solution supply mechanisms at two ends of the machine table 10, the alignment film solution can be supplied to the coating roller 20 at any end of the machine table 10, so that the coating efficiency and the productivity are improved.

In this embodiment, the driving member 70 is preferably an electric cylinder. It should be understood that the driving member 70 may be an air cylinder, a hydraulic cylinder or in other forms, for example, driving by a conveyor belt or a conveyor chain.

The alignment film coater further includes a shaping mechanism for transferring the alignment film solution to the coating roller 20. The shaping mechanism includes a shaping roller 50 and a mount 60. The shaping roller 50 is connected to the mount 60 in such a way that the shaping roller 50 rotates about its axis, and the shaping roller 50 is parallel to the coating roller 20.

Each of the solution supply mechanisms includes a reservoir 30, and a nozzle 40 which is communicated with the reservoir 30 and used for spraying the alignment film solution onto the shaping roller 50. When the alignment film solution is supplied to the coating roller 20, the alignment film solution in the reservoir 30 is sprayed onto the shaping roller 50 by the nozzle 40 and then transferred to the coating roller 20 during the rotation of the shaping roller 50.

The coating roller 20 is connected to the mount 60 in such a way that the coating roller 20 rotates about its axis. The shaping roller 50 is connected to the mount 60 in such a way that the shaping roller 50 rotates about its axis, and the shaping roller 50 is located above the coating roller 50. A telescopic rod of the driving member 70 is fixedly connected to the mount 60, and a driving mechanism for driving the shaping roller 50 and the coating roller 20 to rotate about a fixed axis is fixed on the mount 60.

By the compression between the coating roller 20 and the shaping roller 50 during their rotation, the alignment film solution on the shaping roller 50 is uniformly transferred to the coating roller 20. By connecting the shaping roller 50 and the coating roller 20 through the mount 60, the position of the shaping roller 50 relative to the coating roller 20 during the linear motion of the coating roller 20 remains unchanged, so that it is convenient for the shaping roller 50 to transfer the alignment film solution to the coating roller 20. Meanwhile, when the driving member 70 drives the mount 60 to move, the shaping roller 50 and the coating roller 20 are driven to move synchronously. In this way, the alignment film solution can be supplied to the coating roller 20 at any end of the machine table 10 by only one shaping roller 50.

It is to be noted that, in this embodiment, the driving mechanism is a motor which is in transmission connection to the coating roller 20 and the shaping roller 50.

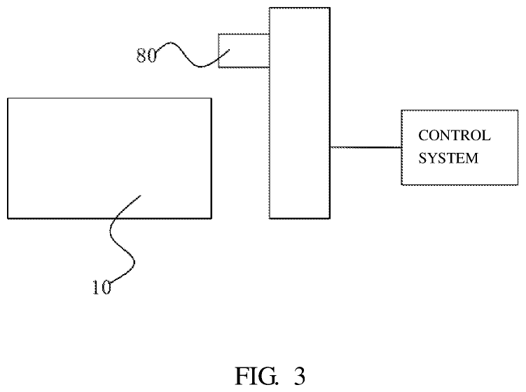

As shown in FIG. 3, the alignment film coater further includes a robot arm 80 for taking a substrate up and down and a control system for controlling the robot arm 80.

Specifically, the control system includes:
a sensing module configured to sense the position of the coating roller 20 and transmit a sensing signal;
a determination module configured to receive the sensing signal, then determine, according to the sensing signal, a position of the coating roller 20 relative to the machine table 10 and generate a result of determination; and
a driving module configured to receive the result of determination and then drive, according to the result of determination, the robot arm 80 to place a substrate of a corresponding type on the machine table 10.

By monitoring the position of the coating roller 20, the control system controls the robot arm 80 to place a substrate, which corresponds to the position of the coating roller 20, on the machine table 10. This prevents the disorder of the TFT substrate and the CF substrate during the alternate coating process.

The present invention has the following beneficial effects. By alternately coating the TFT substrate and the CF substrate, the coated CF substrate and the corresponding TFT substrate can be assembled timely, and the production efficiency and the productivity are thus improved. Meanwhile, by separately controlling the coating of alignment film onto the TFT substrate and the CF substrate, this prevents the disorder of the TFT substrate and the CF substrate during the alternate coating process. Since the alignment film solution can be supplied to the coating roller 20 at both ends of the machine table 10 and the alignment film coating can be implemented in left and right directions. In this way, the time for supplying alignment film solution to the coating roller is saved since the coating roller does not need to return to the original position to be supplied with alignment film solution. Meanwhile, this avoids defective products resulted from the drops of the residual alignment film solution on the substrate during the return of the coating roller 20 to its original position.

In conclusion, although the present invention has been described above by preferred embodiments, the preferred embodiments are not intended to limit the present invention. A person of ordinary skill in the art may make various alterations and modifications without departing from the spirit and scope of the present invention. Therefore, the protection scope of the present invention should be subject to the scope defined by the appended claims.

What is claimed is:

1. An alignment film coating method, comprising steps of:
S10: supplying alignment film solution to a coating roller at a first end of a machine table;
S20: placing a first substrate on the machine table;
S30: linearly moving the coating roller from the first end to a second end of the machine table to coat an alignment film onto the first substrate;
S40: supplying alignment film solution to the coating roller at the second end of the machine table;
S50: taking the first substrate down from the machine table, and placing a second substrate on the machine table; and
S60: linearly moving the coating roller from the second end to the first end of the machine table to coat an alignment film onto the second substrate.

2. The alignment film coating method according to claim 1, wherein the step S30 comprises:
S31: selecting, a position of the coating roller relative to the machine table, the type of a substrate to be placed on the machine table.

3. The alignment film coating method according to claim 2, wherein, in the step S31, when the coating roller is located at the first end of the machine table, a CF substrate is placed on the machine table; and, when the coating roller is located at the second end of the machine table, a TFT substrate is placed on the machine table.

4. The alignment film coating method according to claim 2, wherein, in the step S31, when the coating roller is located at the first end of the machine table, a TFT substrate is placed on the machine table; and, when the coating roller is located at the second end of the machine table, a CF substrate is placed on the machine table.

5. An alignment film coater, comprising:
a machine table;
a coating roller for coating alignment films;
solution supply mechanisms for supplying alignment film solution to the coating roller; and
a driving member for driving the coating roller to linearly move from one end to the other end of the machine table;
wherein the solution supply mechanisms are arranged at two ends of the machine table.

6. The alignment film coater according to claim 5, further comprising a shaping mechanism for transferring the alignment film solution to the coating roller, wherein the shaping mechanism comprises a shaping roller and a mount; and, the shaping roller is connected to the mount in such a way that the shaping roller rotates about its axis, and the shaping roller is parallel to the coating roller.

7. The alignment film coater according to claim 6, wherein each of the solution supply mechanisms comprises a reservoir, and a nozzle which is communicated with the reservoir and used for spraying the alignment film solution onto the shaping roller.

8. The alignment film coater according to claim 6, wherein the coating roller is connected to the mount in such a way that the coating roller rotates about its axis, and the shaping roller is located above the coating roller and comes into contact with the coating roller.

9. The alignment film coater according to claim 5, further comprising a robot arm for placing a substrate on or taking a substrate down from the machine table.

10. The alignment film coater according to claim 9, further comprising a control system for controlling the robot arm, the control system comprising:
a sensing module configured to sense the position of the coating roller and transmit a sensing signal;
a determination module configured to receive the sensing signal, then determine, according to the sensing signal, a position of the coating roller relative to the machine table and generate a result of determination; and
a driving module configured to receive the result of determination and then drive, according to the result of determination, the robot arm to place a substrate of a corresponding type on the machine table.
